(19) United States
(12) Patent Application Publication
(10) Pub. No.: US 2015/0012524 A1
(43) Pub. Date: Jan. 8, 2015

(54) USING MODELS FOR TRIGGERING PERSONAL SEARCH

(71) Applicant: Google Inc., Mountain View, CA (US)

(72) Inventors: Maureen Heymans, San Francisco, CA (US); Harish Rajamani, Sunnyvale, CA (US); Ashutosh Shukla, Mountain View, CA (US); Bryan C. Horling, Sunnyvale, CA (US)

(21) Appl. No.: 13/933,224

(22) Filed: Jul. 2, 2013

(51) Int. Cl. G06F 17/30

(52) U.S. Cl. CPC G06F 17/30424
USPC 707/722

(57) ABSTRACT

Methods, systems, and apparatus, including computer programs encoded on a computer storage medium, for receiving a search query from a user, accessing a user model that is specific to the user and that includes one or more n-grams, one or more terms of the n-grams being associated with one or more annotations, the annotations indicating at least one context in which each of the one or more terms have been used, determining a user intent for the search query based on comparing one or more terms in the search query with the terms of n-grams in the user model, and receiving search results that are responsive to the search query, the search results being specific to the user intent.

### BACKGROUND

This specification relates to presenting data with search results.

The Internet provides access to a wide variety of resources, such as image files, audio files, video files, and web pages. A search system can identify resources in response to queries submitted by users and provide information about the resources in a manner that is useful to the users. The users then navigate through (e.g., click on) the search results to acquire information of interest to the users.

Users of search systems are often searching for information regarding a specific entity. For example, users may want to learn about a singer that they just heard on the radio. Conventionally, the user would initiate a search for the singer and select from a list of search results determined to be relevant to the singer.

### SUMMARY

Implementations of the present disclosure are generally directed to providing a data model, referenced herein as user model, on a user-by-user basis and using the user model to selectively provide user-specific search results (personal search results) based on a determined user intent. More particularly, implementations of the present disclosure are directed to determining information, including words, from user-generated content, e.g., electronic documents, that is personal to each user, and storing the information in a user model. In response to a search query received from the user, the user model can be used to determine an implicit intent of the user, e.g., to receive user-specific (personal) search results. In some implementations, the search query can be annotated based on the associated user model. In some examples, if an implicit intent is determined, the user model can be used to provide user-specific search results.

In general, innovative aspects of the subject matter described in this specification can be embodied in methods that include actions of receiving a search query from a user, accessing a user model that is specific to the user and that includes one or more n-grams, one or more terms of the n-grams being associated with one or more annotations, the annotations indicating at least one context in which each of the one or more terms have been used, determining a user intent for the search query based on comparing one or more terms in the search query with the terms of n-grams in the user model, and receiving search results that are responsive to the search query, the search results being specific to the user intent. Other implementations of this aspect include corresponding systems, apparatus, and computer programs, configured to perform the actions of the methods, encoded on computer storage devices.

These and other implementations can each optionally include one or more of the following features: the user intent includes at least one of a personal intent and a general intent, the personal intent includes an intent to retrieve search results that are specific to the user, the general intent comprises an intent to retrieve search results that are agnostic to the user, determining a user intent includes: determining an intent score based on the search query and the user model, and comparing the intent score to one or more threshold intent scores; the intent score indicates a likelihood that the user intent is a personal intent; actions further include determining that the intent score exceeds a threshold intent score and, in response, determining that the user intent includes a personal intent; actions further include determining that the intent score is less than a first threshold intent score and exceeds a second threshold intent score and, in response, determining that the user intent includes a personal intent and a general intent; and the intent score is determined based on one or more of a freshness of the particular n-grams in the user model, closeness of matches between terms in the search query and n-grams in the user model, a quality of search results that could be displayed to the user in response to the search query, and user search history.

Particular implementations of the subject matter described in this specification can be implemented so as to realize one or more of the following advantages. For example, the user intent is determined even before a search is performed on the user-specific data. In this manner, search queries can be pre-filtered before performing the expensive search operations, thereby saving bandwidth and computing resources. As another example, by using the user model for annotating the query, it is possible to understand the user query before performing the search. For example, an example query [meeting with jinan] can be processed to determine that jinan is a person's name and not a city, e.g., disambiguation. This enables execution of more accurate queries and reduces variations of the query. As another example, determining implicit user intent reduces the burden on the user to explicitly indicate when they are looking for personal data. For example, instead of the search query [my flights on airline] to look up the upcoming flights with “airline,” the user can instead just submit [airline].

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a search system provides search services.

FIG. 2 depicts example components that can be used to provide implementations of the present disclosure.

FIG. 3 depicts an example process for providing user-specific models.

FIG. 4 depicts an example process for determining intent based on a user-specific model.

FIG. 5 depicts an example process for annotating queries based on user-specific models.

Like reference numbers and designations in the various drawings indicate like elements.

### DETAILED DESCRIPTION

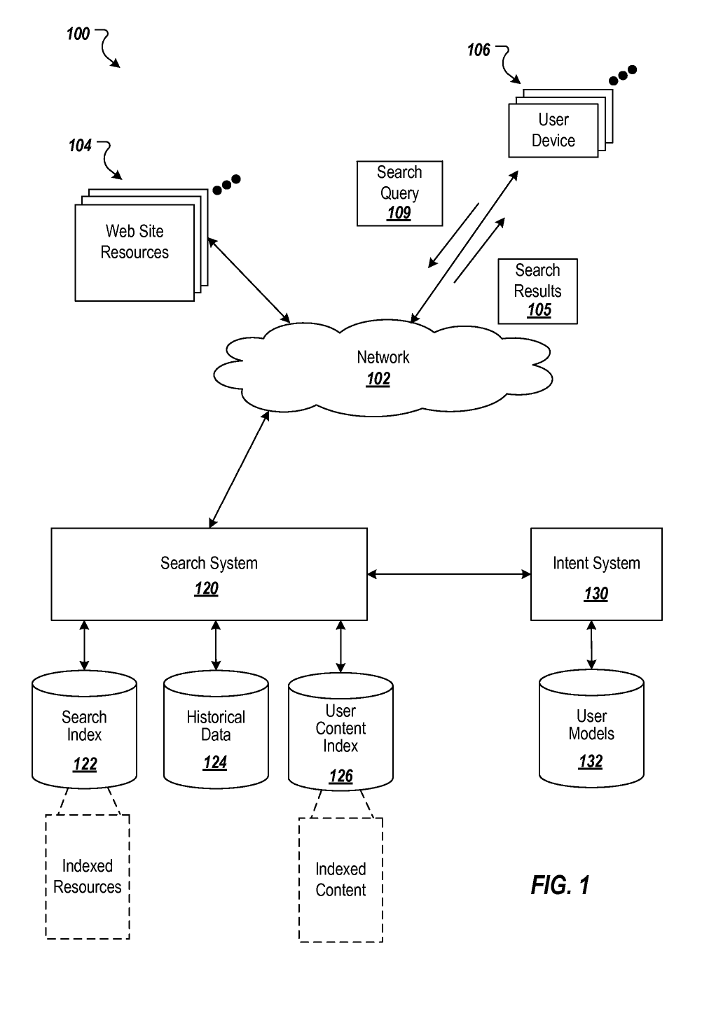

FIG. 1 is a block diagram of an example environment 100 in which a search system 120 provides search services. The example environment 100 includes a network 102 that connects resources 104, user devices 106, and the search system 120 for communication therebetween. Example resources can include web sites. In some examples, the network 102 includes a local area network (LAN), wide area network (WAN), the Internet, telephone networks, e.g., public switched telephone network (PSTN) and/or cellular network, or any appropriate combination thereof.

In some examples, a user device 106 is an electronic device that is under control of a user and is capable of requesting and receiving resources 104 over the network 102. In some examples, user devices 106 can include a mobile phone, a smartphone, a personal digital assistant (PDA), a laptop computer, a desktop computer, a tablet, and any appropriate combinations thereof. As used throughout this document the term mobile computing device (“mobile device”) refers to a user device that is configured to communicate over a mobile communications network. A smartphone, e.g., a phone that is enabled to communicate over the Internet, is an example of a mobile device. A user device 106 can execute an application, e.g., a web browser, to facilitate display of information sent/received over the network 102, and to facilitate receipt of user input.

In some examples, the network 102 can be accessed over a wired and/or a wireless communications link. In some examples, computing devices, e.g., smartphones, can utilize a cellular network to access the network 102. For example, communication can be provided under various modes or protocols. Example protocols can include SMS, EMS or MMS messaging, GSM, TCP, UDP, RTP, VoIP, FDMA, CDMA, TDMA, PDC, WCDMA, CDMA2000, TD-SCDMA and/or GPRS. Such communication may occur, for example, through a radio-frequency transceiver (not shown). In some examples, user devices 106 can be capable of short-range communication using features including, but not limited to, Bluetooth and/or WiFi transceivers.

In some examples, a web site is provided as one or more resources 104 associated with a domain name and hosted by one or more servers. An example web site is a collection of web pages formatted in hypertext markup language (HTML) that can contain text, images, multimedia content, and programming elements, e.g., scripts. Each web site is maintained by a publisher, e.g., an entity that manages and/or owns the web site.

In some examples, a resource 104 is data provided over the network 102 and that is associated with a resource address, e.g., a uniform resource locator (URL). Resources 104 that can be provided can include HTML pages, word processing documents, and portable document format (PDF) documents, images, video, and feed sources, to name just a few. The resources 104 can include content, e.g., words, phrases, images and sounds and may include embedded information, e.g., meta information and hyperlinks, and/or embedded instructions, e.g., scripts.

In some examples, and to facilitate searching of resources 104, the search system 120 identifies the resources 104 by crawling and indexing the resources 104 provided on web sites, for example. Data about the resources 104 can be indexed based on the resource to which the data corresponds. The indexed and, optionally, cached copies of the resources 104 are stored in a search index 122.

In some examples, the user devices 106 submit search queries 109 to the search system 120. In response, the search system 120 accesses the search index 122 to identify resources 104 that are relevant to, e.g., have at least a minimum specified relevance score for, the search query 109. The search system 120 identifies relevant resources 104, generates search results 111 that identify the resources 104, and returns the search results 111 to the user devices 106. In some examples, a search results page 105 is data generated by the search system 120 that identifies a resource 104 that is responsive to a particular search query, and includes a link to the resource 104. An example search results page 105 can include search results represented as a web page title, a snippet of text or a portion of an image extracted from the web page, and the URL of the web page.

Data for the search queries 109 submitted during user sessions are stored in a data store, such as the historical data store 124. For example, the search system 110 can store received search queries in the historical data store 124.

Selection data specifying actions taken in response to search results provided in response to each search query 109 are also stored in the historical data store 124, for example, by the search system 120. These actions can include whether a search result was selected, e.g., clicked or hovered over with a pointer. The selection data can also include, for each selection of a search result, data identifying the search query 109 for which the search result was provided.

In some implementations, the search system 120 can provide user-specific search results, e.g., personal search results. In some examples, a user of the search system can be a user of one or more computer-implemented services. Example computer-implemented services can include an electronic mail service, a chat service, a contact management service, a social networking service, a blogging service and a micro-blogging service. Use of computer-implemented services can result in user-generated content. For example, a user of an electronic mail service can send and/or receive electronic messages, the electronic messages including user-generated content therein, e.g., content in the subject line of a message, content in the body of a message. As another example, a user of a social networking service can generate, view, and/or interact with, e.g., comment on, endorse, re-share, posts that are distributed through the social networking services. In this example, the user posts and/or the user interactions are user-generated content.

In some implementations, user-specific search results can include search results that are provided based on user-generated content. In some examples, and to facilitate searching of user-generated content, the search system 120 identifies user-generated content by crawling and indexing user-generated across one or more computer-implemented services, for example. User content data can be indexed based on the user-generated content to which the data corresponds. The indexed and, optionally, cached copies of the user-generated content are stored in a user content index 126.

In accordance with implementations of the present disclosure, the search system 120 can interact with an intent system 130 to determine an intent associated with a received search query. In some examples, an intent can include an implicit intent that reflects a user's intention in submitting the search query. In some examples, and as discussed in further detail herein, implicit intent can be determined based on a user model that is specific to the user that submitted the search query. In some examples, user-specific user models are provided in a user models data store 132. In some examples, and as discussed in further detail, user models are provided on a per user basis, where each user model is specific to a particular user. In accordance with implementations of the present disclosure, user models are provided based on user-generated data from use of one or more computer-implemented services, as discussed above. In some implementations, an intent of a user submitting a search query is determined based on an associated user model, and the search query can be annotated based on the associated user model to provide user-specific search results.

Implementations of the present disclosure are generally directed to generating a data model, referenced herein as a user model, on a user-by-user basis and using the user model to selectively provide user-specific search results based on a determined user intent. More particularly, implementations of the present disclosure are directed to determining information, including words, from user-generated content, e.g., electronic documents, that is personal to each user, and storing the information in a user model. In response to a search query received from the user, the user model can be used to determine an implicit intent of the user, e.g., to receive user-specific (personal) search results, and/or web-based (general) search results. In some examples, if a personal intent is determined, the user model can be used to provide user-specific search results. In some implementations, the search system 120 may identify relevant data from the user-generated content and provide that content in a manner that mirrors conventional search results.

In some implementations, a user model is provided from user-generated content. In some implementations, the user model includes information provided within the user-generated content associated with the particular user. As one example, user-generated content can include an electronic mail message sent or received by the user using an electronic mail service. For example, the electronic mail message can be sent by the user and can include “ProjectX” in the subject line, and “Joe Smith is heading up ProjectX for our team” in the body. As another example, user-generated content can include a contact record stored by the user in a contact management service. For example, a contact record can be associated with a contact “Joe Smith.”

In accordance with implementations of the present disclosure, the user model includes a plurality of n-grams. In some examples, each n-gram includes one or more terms provided from the user-generated content. Continuing with the examples above, a plurality of n-grams can be provided from the example electronic mail message and the example contact record. Example n-grams can include: {ProjectX}; {Joe}; {Smith}; {Joe Smith}; {Joe, Smith}; {ProjectX, Joe}; {ProjectX, Smith}; {ProjectX, Joe Smith}, and the like.

In some examples, information that is determined to be of potential interest to the user is included in the user model. As an example, proper nouns or other words that have a probability of being of interest to the particular user can be included in the user model. As another example, certain content, e.g., stop-words, such as “a,” “the,” “and” and other stop-words, can be filtered such that those words are omitted from the user model for the particular user.

In some implementations, n-grams can be included in the particular user model for a certain period of time. After that time period expires, n-grams can be removed from the user model. Consider, for example, user-generated content from a social networking service. At first, n-grams based on the user-generated content from the social networking service may be stored in a user model for the particular user. This may occur because, for example, social networking services can be considered more personal in nature and an assumption can be made that content associated with activities performed using the social networking service should be stored, at least initially, in the user model for the particular user.

Continuing with this example, if particular acquaintances are the topic of a post or the target of some other social networking activity with sufficient frequency, those acquaintances may be maintained in the user model. Whereas particular acquaintances associated with activities that do not occur with sufficient frequency may be removed over some period of time, depending on particular implementations. That is, if certain words or topics are of particular interest to a particular user, those words or topics are likely to occur in the user-generated content with a frequency that is sufficient to identify those words as being of potential interest to the particular user, and keeping the associated n-grams in the user model of the particular user.

In some implementations, the user model can be updated based on subsequent actions. For example, if the particular user deletes an electronic mail message, the user model associated with the particular user can be updated to remove n-grams associated with the deleted electronic mail message. Also, as mentioned above, data from user models can be removed after an elapsed time to maintain a certain level of data relevance, or freshness, in the user model. In some examples, the timing may differ based on the type of data. For example, n-grams provided from user-generated content associated with a dinner reservation can be removed from the user model after a relatively short period of time, while n-grams associated with the name of the particular user's alma mater can persist for a longer period of time in the user model. In general, and in some examples, each n-gram can be associated with a freshness provided in terms of time, and can be compared to a threshold freshness. In some examples, if the freshness of an n-gram exceeds the threshold freshness, the n-gram can be removed from the user model.

In some implementations, terms of n-grams within the user model can be annotated. In this manner, the data of the user model can be provided as structured data. Example annotations can include name, first name, last name, address, person, object, subject, date, time, location and the like. It is appreciated that the example annotations provided herein are non-exhaustive examples of annotations that could be used to annotate terms of n-grams in a user model. In some implementations, annotations can be provided from an annotation service, e.g., provided as one or more computer-executable programs. In some examples, the annotations service can process n-grams in view of user-generated content, from which the n-grams are provided, to provide annotations to terms of the n-grams.

In some examples, annotations are provided to terms based on the source of the terms, e.g., the user-generated content, and/or a context. As an example, the user can have “Max” as a contact, e.g., in a computer-implemented contact management service. Thus, the term “Max” may appear in an n-gram of the user model for the user. In the user-generated content, in which the term “Max” appears, the term “Max” can be associated with an attribute identifier, such as name or first name. Consequently, in the user model, the term “Max” can be annotated with name, first name, and/or person. As another example, the user can receive can electronic mail message from “Max” through an electronic mail service. Thus, the term “Max” may appear in an n-gram of the user model for the user. In the user-generated content, in which the term “Max” appears, the term “Max” can be associated with a sender electronic mail address and/or can be included in the body of the electronic mail message, e.g., in a signature line. Consequently, this context can result in the term “Max” being annotated with name, first name, and/or person within the user model. In this manner, for example, the name “Max” can be distinguished from the mathematical operator “max,” when retrieving search results.

In accordance with implementations of the present disclosure, a user intent in submitting a search query can be determined. Example intents can include an intent to retrieve general search results, general intent, e.g., based on information published to the Internet, and/or an intent to retrieve personal search results, personal intent, e.g., based on user-generated content associated with the particular user across one or more computer-implemented services used by the user. In some implementations, search intent can be determined in one or more manners. In some examples, general search results include search results that are agnostic to the user, and personal search results include search results that are specific to the user.

In some implementations, intent can be determined based on the user model. In some examples, terms provided in the search query can be used for comparison to n-grams provided in a user model. In some examples, if terms and/or n-grams provided from terms in the search query match, or sufficiently match, n-grams in the user model, the intent can be determined to be an intent to retrieve personal search results. Continuing with the examples above, an example search query can include [ProjectX Joe Smith]. Consequently, the search query can be determined to correspond to, or match one or more n-grams of the user model, e.g., {ProjectX}; {Joe}; {Smith}; {Joe Smith}; {Joe, Smith}; {ProjectX, Joe}; {ProjectX, Smith}; {ProjectX, Joe Smith}, indicating an intent to retrieve personal search results.

In some implementations, matches between terms in a received search query and n-grams in the user model can be scored based on the age, or freshness of the particular n-grams in the user model. For example, a particular n-gram of the user model can be provided from an electronic mail message associated with the particular user. A freshness score associated with the n-gram can be provided based on an age of the electronic mail message. For example, if the electronic mail message was sent/received one year ago, the n-gram can be associated with a first freshness score. If the electronic mail message was sent/received yesterday, the n-gram can be associated with a second freshness score that is greater than the first freshness score. In some examples, the freshness score can be used to supplement the intent of the user. For example, n-gram in the user model with a relatively high freshness score can be indicative of personal intent, whereas n-grams in the user model with a relatively low score can be indicative of another intent, e.g., web-based intent.

In some implementations, scores can be based on a closeness of a match between the terms in the search query and n-grams in the user model. For example, synonyms of search query terms can be provided and can be compared to n-grams of the user model. A synonym match to an n-gram can be associated with a first score, and an identical match between an original term and an n-gram can be associated with a second score, the second score being greater than the first score.

In some implementations, intent can be determined based a quality of the search results that could be displayed to the user. For example, relevance scores and a number of clicks that have resulted from the search results as previously presented can be indicative of the user's search intent. For example, if the user historically clicks links to public documents in response to obtaining search results, one or more of the query terms provided in the search query used in obtaining those search results may be more strongly associated with a web-based intent. As another example, if the user historically clicks links to private documents and/or other private search results in response to obtaining those search results, one or more of the query terms provided in the search query used in obtaining those search results can be more strongly associated with a personal intent.

In some implementations, an intent score can be provided and can be compared to one or more threshold intent scores to determine an intent associated with submission of the search query. In some examples, the intent score is provided based on one or more scores. In some examples, the one or more scores can include scores discussed herein and/or other scores. In some examples, the intent score can be provide based on a combination of scores, where respective weights are applied to the scores.

In some examples, the intent score can be compared to a first threshold intent score and, if the intent score exceeds the first threshold intent score, the intent can be determined to be personal intent. Consequently, the search results can include personal search results, or a mixture of personal search results and general search results with the personal search results displayed more prominently than the general search results. In some examples, the intent score can be compared to the first threshold intent score and a second threshold intent score that is less than the first threshold intent score. If the intent score exceeds the second threshold intent score and does not exceed the first threshold intent score, the intent can be determined to be a combination of personal intent and general intent. Consequently, the search results can include personal search results and general search results displayed with relatively equal prominence. In some examples, if the intent score exceeds the second threshold intent score and does not exceed the first threshold intent score, additional evaluations can be conducted to determine whether the intent is personal intent and/or general intent, as discussed in further detail herein. In some examples, if the intent score does not exceed the second threshold intent score, the intent can be determined to be general intent. Consequently, the search results can include general (web) search results, or a mixture of personal search results and general search results with the general search results displayed more prominently than the personal search results.

In some implementations, the search intent can be based on an interest window. For example, factors can be compared to determine an interest window, and the interest window can be used to determine whether the received search query is associated with web-based intent, personal intent, or a combination thereof. An example factor can include a predetermined period of time between the occurrence of a particular event in the user model and when the search query is received. In some examples, a type of the event can be used to provide the predetermined period of time.

As an example, a user has a flight with Consolidated Airlines X days, e.g., three (3), or more days, in the future when the user submits the example search query [consolidated airlines]. In this example, terms in the query can be included in n-grams of the user model, but the amount of time between the user submitting the search query and the scheduled flight, can indicate that the user intends a web search and not a personal search, e.g., because the period of time falls outside an interest window. As another example, if that same booked flight is less than 24 hours in the future when the user submits the search query [consolidated airlines], the close proximity to the time of the flight can indicate that the user intends a personal search for the particulars of the booked flight, e.g., because the period of time falls inside the interest window. As another example, a dinner reservation can have a different predetermined period of time, e.g., a few hours, in which search queries are considered to fall within the interest window.

In some examples, terms provided in a search query can indicate an intent. For example, an example search query [E-Commerce website] can be associated with a strong web-based intent, e.g., to navigate to the website operated by the company “E-Commerce, Inc.”

In some implementations, one or more search results can be displayed in a user interface depending on a determined confidence level of the user intent. For example, personal search results that are responsive to the search query can be shown prominently, in response to a high confidence that the intent is a personal intent. For example, personal search results can be displayed in an area of a user interface that is specific to personal search results. In some examples, if the confidence level is somewhat less, the personal search results can be degraded, collapsed, or otherwise shifted to reflect the lower degree of confidence that the intent was a personal intent.

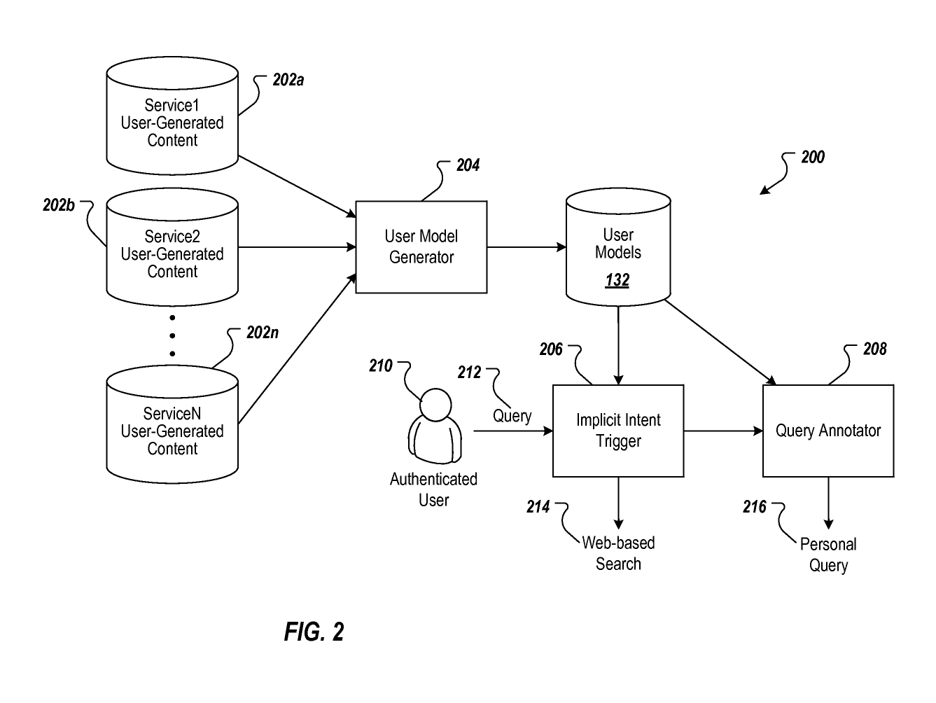

FIG. 2 is a block diagram of example components 200 that can be used to provide implementations of the present disclosure. The example components 200 include one or more user-generated content data stores 202a-202n, a user model generator component 204, the user models data store 132, an implicit intent trigger component 206, and a query annotator component 208. The components 200 can be used to obtain search results to be displayed to an authenticated user 210 of a computer-implemented search service. In some implementations, the authenticated user 210 is authenticated by a combination of providing a user-name and password into a user interface provided by a computer-implemented search service. In some examples, components are provided as one or more computer-executable programs executed using one or more computing devices.

In some examples, the user-generated content data stores 202a-202n store information directed to user-generated content that is created using respective computer-implemented services. Examples of services can include a social networking service, an electronic messaging service, a search service, a map service, a document sharing service, and other services. The user-generated content data stores 202a-202n can be any computer-readable storage device and may be centrally located on a single server or computing device or distributed across multiple servers or computing devices, according to particular implementations.

In some examples, user-generated content data stores 202a-202n can store one or more documents that relate in some way to the user-generated content. For example, if one of the user-generated content data stores 202a-202n stores information that corresponds to activities performed using an electronic mail service, electronic documents that are created by the user using the electronic mail service can be stored in the particular user-generated content data store.

In some examples, the user model generator component 204 can receive or otherwise access one or more documents or other information stored in the user-generated content data stores 202a-202n and generate, modify, or otherwise maintain the user models stored in the user model data store 132. In some examples, the user model generator component 204 can generate a user model based on a determination that particular aspects of the user-generated content is of particular interest to the user. That is, in some examples, the user model generator component 204 can generate a particular user model by determining that one or more terms included in documents stored in the user generated content data stores 202a-202n are of particular interest to a user associated with the particular user model.

In some examples, the implicit intent trigger component 206 can determine whether a particular authenticated user 210 is providing a search query 212 to obtain user-specific (personal) search results or non-user-specific (non-personal) search results. That is, the implicit intent trigger component 206 can determine whether the intent is web-based intent, a personal intent, or a combination thereof, as discussed herein. In some examples, the authenticated user 210 is authenticated by a combination of providing a user-name and password into a user interface provided by the computer-implemented search service.

In some implementations, the implicit intent trigger component 206 may implicitly determine intent using a number of different techniques. In some examples, the implicit intent trigger component 206 can determine an intent score for a particular search query. If the intent score satisfies a particular threshold, the implicit intent trigger component 206 can direct a search system to perform a user-specific (personal) search or may otherwise provide an appropriate indication to the query annotator component 208. In some examples, the score can be based on a user interest window, personal and non-personal weights associated with certain terms in the search query, historical information concerning the quality of previous search results using similar search terms, or other aspects of a particular user model in the user models data store 132.

If, for example, the implicit intent trigger component 206 does not determine that a search query is directed at a user-specific (personal) search, a non-personal collection of search results, e.g., web-based search results, may be provided for display to the authenticated user 210. That is, in some examples, the search query 212 may be processed by a search system in a conventional manner to provide conventional search results. In some examples, the implicit intent trigger may cause a signal 214 to be sent to the search system, e.g., the search system 120, indicating that web-based search results are to be provided based on the query 212. If, for example, the implicit intent trigger component 206 determines that a search query is directed at a user-specific (personal) search, the implicit intent trigger component 206 may provide the search query 212 to the query annotator 208.

In some examples, the query annotator component 208 can annotate one or more query terms in a received search query according to information stored in the a specific user model for the authenticated user 210. In some examples, the user model for the authenticated user 210 is accessed from the user models data store 132 to identify annotations. The query terms can be annotated by the query annotator component 208 to provide a personal query 216 to the search system, e.g., the search system 120. The personal query 216 can be used to cause personal search results to be provided to the authenticated user 210.

With regard to query annotations, an example above is referenced. For example, consider a situation where the authenticated user 210 has “Max” as a contact, e.g., in a computer-implemented service. Thus, the term “Max” may appear in a user model for the authenticated user 210, and can be annotated with example annotations of name, first name, and/or person. If the authenticated user 210 provides a subsequent search query 212 that includes the query term “max,” the query annotator component 208 can annotate that term as a person to provide a personal query 216. In this manner, the personal query 216 can be used to provide personal search results associated with “Max” the person instead of “max” the mathematical operator (where results using “max” the mathematical operator may not be of a personal nature).

In some implementations, the query annotator component 208 can match the annotated queries to a grammar of query patterns. This matching can be used to determine what the particular user is searching for and provide improved queries that correspond to personal information, e.g., an improved query for personal information. That is, in some examples, the improved query for personal information can be provided to a search system to obtain search results that include personal results. For example, a submitted query [find all of the emails from Max] can be matched with a query pattern [emails from /Sender/], where “/Sender/” is a generalized aspect of the query pattern and can be used to match any aspect of the received query pattern that is annotated as a “/Sender/,” such as “Max” in the above example. In some implementations, this matching can be performed regardless of the user intent determined by the implicit intent trigger component 206. In some implementations, this matching can be influenced by the presence or absence of annotated terms in the user model for the authenticated user 210, as will be described.

In some examples, this approach can be used to determine more accurate query patterns regarding received queries for which the search system has limited exposure. For example, an example query can be provided as [find all of the e-mails from Max mentioning Zack]. In some examples, a search system can determine that the general topic of the search is “Max mentioning Zack” and perform such a search using a query pattern [e-mails about /Topic/]. In the above example, however, the system can determine that, because the term “mentioning” has not been used by the user before, e.g., in user-generated content, and that it is not as important as the term “Max,” which has been stored in the user's particular user model. Under these example circumstances, the search system can determine that a better query pattern to match is [e-mails from /Sender/ with /Modifier/], where the “/Modifier/” term is “mentioning Zack,” or “Zack,” depending on particular implementations.

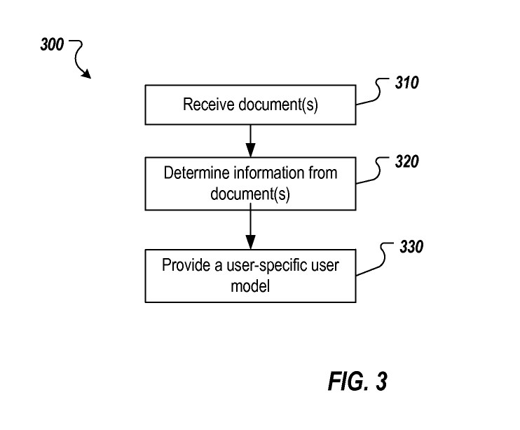

FIG. 3 depicts an example process 300 providing user-specific models. The example process 300 can be implemented, for example, by the search system 120 in conjunction with the intent system 130 of FIG. 1, and/or the example components 200 of FIG. 2. In some examples, the example process 300 can be provided using one or more computer-executable programs that can be executed by data processing apparatus.

One or more documents are received (310). In some examples, documents include user-generated content that is associated with a user and that is provided through use of computer-implemented services. In some examples, documents can be received by the user model generator component 204 from data stores 202a-202n associated with respective computer-implemented services. For example, an electronic mail message can be received by the user model generator component 204. As another example, an electronic document that is shared between users of a document sharing service can be received by the user model generator component 204.

Information from the one or more documents can be determined (320). In some examples, information determined from the one or documents can include information that is of potential interest to the user, with which the one or more documents are associated. In some examples, one or more words, terms, or concepts, in the received documents can be identified based on the document(s). For example, words, terms, or concepts related to a sender or title of an electronic mail message may be identified. As another example, words, terms, or concepts associated with a destination and/or time of day for an appointment may be identified. As yet another example, stop-words such as “a,” “the,” and other stop-words may not be identified, regardless of the type of document received.

A user specific model for the user is provided (330). In some examples, the user model can include one or more terms provided as one or more n-grams. In some examples, the user model can include one or more associations that indicate at least one context in which each of the one or more terms have been used. In some examples, the associations can be provided as annotations to terms provided in the n-grams. In some examples, the at least one context is based on information determined from the document(s). For example, if an electronic mail message is sent to a recipient “Max,” the term “Max” may be annotated with name, first name, person, recipient, and/or other associations, because the term “Max” was identified in the context of an electronic mail message.

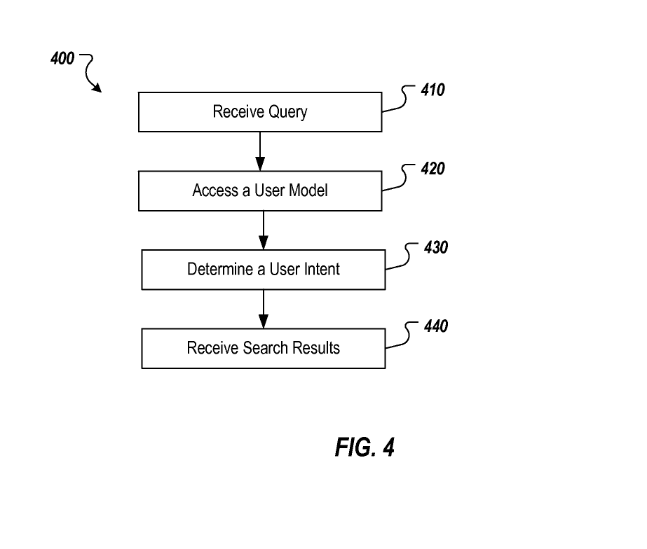

FIG. 4 depicts an example process 400 for determining intent based on a user-specific model. The example process 400 can be implemented, for example, by the search system 120 in conjunction with the intent system 130 of FIG. 1, and/or the example components 200 of FIG. 2. In some examples, the example process 400 can be provided using one or more computer-executable programs that can be executed by data processing apparatus.

A search query is received from a user (410). For example, the search system 120 can receive a search query [consolidated airlines] from a computing device of the user, e.g., through a user interface presented on the computing device. As another example, the search query [consolidated airlines] may be received from an automated system where the search query is nevertheless associated with a user.

A user model that is specific to the user is accessed (420). In some examples, the user model includes one or more n-grams each including one or more terms, each term including one or more annotations. In some examples, the intent system 130 accesses the user model from the user model data store 132. In some examples, a unique identifier associated with the user can be used to identify the appropriate user model from a plurality of user models.

A user intent for the search query is determined (430). For example, the intent system 130, e.g., the implicit intent trigger 206, can implicitly determine the user intent based on one or more factors, and/or an intent score determined for the query, as discussed in detail herein.

Search results are received based on the determined intent (440). In some examples, and as discussed above, the intent can include a web-based intent, a personal intent, or a combination thereof. In some examples, intent is determined based on comparing terms in the search query to n-grams of the user model, as discussed in detail herein. In some examples, the intent is determined to be a web-based intent. Consequently, web-based search results that are responsive to the search query are received. In some examples, the intent is determined to be a personal intent. Consequently, personal search results that are responsive to the search query are received. In some examples, personal search results reflect one or more documents associated with the user in the computer-implemented services. In some examples, the intent is determined to be a combination of web-based intent and personal intent. Consequently, web-based search results and personal search results that are responsive to the search query are received.

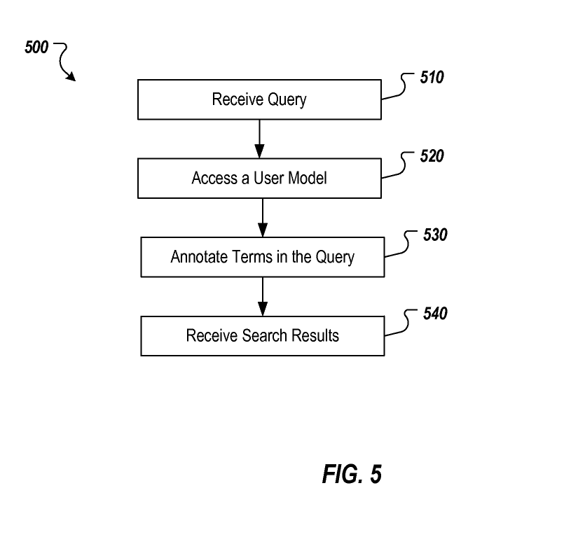

FIG. 5 depicts an example process 500 for annotating queries based on user-specific models. The example process 500 can be implemented, for example, by the search system 120 in conjunction with the intent system 130 of FIG. 1, and/or the example components 200 of FIG. 2. In some examples, the example process 500 can be provided using one or more computer-executable programs that can be executed by data processing apparatus.

A search query is received from a user (510). In some examples, the user submits a search query to the search system 120 through an interface provided on a computing device. In some examples, the search system 120 provides the search query to the intent system 130, e.g., the implicit intent trigger component 206. For example, the example search query [emails from max] can be received.

A user model is accessed (520). In some examples, the user model includes one or more n-grams each including one or more terms, each term including one or more annotations. In some examples, the intent system 130 accesses the user model from the user model data store 132. In some examples, a unique identifier associated with the user can be used to identify the appropriate user model from a plurality of user models.

One or more terms in the search are annotated (530). For example, the query annotator component 208 annotates the search query to provide a personal query. In some examples, the one or more terms may be annotated based on annotations provided in the user model. As discussed above, the example search query [emails from max] can be received. In some examples, the user model includes the term “max” that was identified in the “from” field of an electronic mail message, and the term “max” is annotated with name, first name, sender, and/or person, or other appropriate annotation, within the user model. Continuing with this example, the search query can be annotated with one or more annotations provided for the term “max” within the user model to provide the personal query. In some examples, annotation of the query to provide the personal query is performed in response to determining that the intent is a personal intent, or a combination of a web-based intent and a personal intent.

Search results are received based on the annotated search query (540). In some implementations, the search results can be received from a search system that is sent one or more query patterns in a grammar of query patterns that are matched to the annotated search query, e.g., the personal query. For example, a submitted query [find all of the emails from Max] can be matched with a query pattern [emails from /Sender/], where “/Sender/” is a generalized aspect of the query pattern and can be used to match any aspect of the received query pattern that is annotated as a “/Sender/,” such as “Max” in the above example.

The generalized search query [emails from /Sender/] can be provided to the search system. In response, the search system can locate search results that are specific to the user and search results that are not specific to the user. If, for example, a personal intent is determined for the annotated query, then the query pattern [emails from /Sender/] using “Max” as the “/Sender/” can locate personal electronic messages sent by Max to the user.

Where user information may be collected or used by the systems discussed here, or the systems discussed here may make use of users information, users may be given an opportunity to control whether the user information, e.g., information about a user's social network, social actions or activities, profession, a user's preferences, or a user's current location, is collected, and to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized so that a particular location of a user cannot be determined.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method executed using one or more processors, the method comprising:
receiving, by the one or more processors, a search query from a user;
accessing, by the one or more processors, a user model that is specific to the user and that includes one or more n-grams, one or more terms of the n-grams being associated with one or more annotations, the annotations indicating at least one context in which each of the one or more terms have been used;
determining, by the one or more processors, a user intent for the search query based on comparing one or more terms in the search query with the terms of n-grams in the user model; and
receiving search results that are responsive to the search query, the search results being specific to the user intent.

2. The method of claim 1, wherein the user intent comprises at least one of a personal intent and a general intent.

3. The method of claim 2, wherein the personal intent comprises an intent to retrieve search results that are specific to the user.

4. The method of claim 2, wherein the general intent comprises an intent to retrieve search results that are agnostic to the user.

5. The method of claim 1, wherein the determining a user intent comprises:
determining an intent score based on the search query and the user model; and
comparing the intent score to one or more threshold intent scores.

6. The method of claim 5, wherein the intent score indicates a likelihood that the user intent is a personal intent.

7. The method of claim 5, further comprising determining that the intent score exceeds a threshold intent score and, in response, determining that the user intent comprises a personal intent.

8. The method of claim 5, further comprising determining that the intent score is less than a first threshold intent score and exceeds a second threshold intent score and, in response, determining that the user intent comprises a personal intent and a general intent.

9. The method of claim 5, wherein the intent score is determined based on one or more of a freshness of the particular n-grams in the user model, closeness of matches between terms in the search query and n-grams in the user model, a quality of search results that could be displayed to the user in response to the search query, and user search history.

10. A system comprising:
one or more data sources; and
one or more processors configured to interact with the one or more data sources, the one or more processors being further configured to perform operations comprising:
receiving a search query from a user;
accessing a user model that is specific to the user and that includes one or more n-grams, one or more terms of the n-grams being associated with one or more annotations, the annotations indicating at least one context in which each of the one or more terms have been used;
determining a user intent for the search query based on comparing one or more terms in the search query with the terms of n-grams in the user model; and
receiving search results that are responsive to the search query, the search results being specific to the user intent.

11. The system of claim 10, wherein the user intent comprises at least one of a personal intent and a general intent.

12. The system of claim 11, wherein the personal intent comprises an intent to retrieve search results that are specific to the user.

13. The system of claim 11, wherein the general intent comprises an intent to retrieve search results that are agnostic to the user.

14. The system of claim 10, wherein the determining a user intent comprises:
determining an intent score based on the search query and the user model; and
comparing the intent score to one or more threshold intent scores.

15. The system of claim 14, wherein the intent score indicates a likelihood that the user intent is a personal intent.

16. The system of claim 14, wherein operations further comprise determining that the intent score exceeds a threshold intent score and, in response, determining that the user intent comprises a personal intent.

17. The system of claim 14, wherein operations further comprise determining that the intent score is less than a first threshold intent score and exceeds a second threshold intent score and, in response, determining that the user intent comprises a personal intent and a general intent.

18. The system of claim 14, wherein the intent score is determined based on one or more of a freshness of the particular n-grams in the user model, closeness of matches between terms in the search query and n-grams in the user model, a quality of search results that could be displayed to the user in response to the search query, and user search history.

19. A computer readable medium storing instructions that, when executed by one or more processors, cause the one or more processors to perform operations comprising:
receiving a search query from a user;
accessing a user model that is specific to the user and that includes one or more n-grams, one or more terms of the n-grams being associated with one or more annotations, the annotations indicating at least one context in which each of the one or more terms have been used;
determining a user intent for the search query based on comparing one or more terms in the search query with the terms of n-grams in the user model; and
receiving search results that are responsive to the search query, the search results being specific to the user intent.

20. The computer readable medium of claim 19, wherein the user intent comprises at least one of a personal intent and a general intent.

21. The computer readable medium of claim 20, wherein the personal intent comprises an intent to retrieve search results that are specific to the user.

22. The computer readable medium of claim 20, wherein the general intent comprises an intent to retrieve search results that are agnostic to the user.

23. The computer readable medium of claim 19, wherein the determining a user intent comprises:
determining an intent score based on the search query and the user model; and
comparing the intent score to one or more threshold intent scores.

24. The computer readable medium of claim 23, wherein the intent score indicates a likelihood that the user intent is a personal intent.

25. The computer readable medium of claim 23, wherein operations further comprise determining that the intent score exceeds a threshold intent score and, in response, determining that the user intent comprises a personal intent.

26. The computer readable medium of claim 23, wherein operations further comprise determining that the intent score is less than a first threshold intent score and exceeds a second threshold intent score and, in response, determining that the user intent comprises a personal intent and a general intent.

27. The computer readable medium of claim 23, wherein the intent score is determined based on one or more of a freshness of the particular n-grams in the user model, closeness of matches between terms in the search query and n-grams in the user model, a quality of search results that could be displayed to the user in response to the search query, and user search history.
